(19) United States
(12) Patent Application Publication
(10) Pub. No.: US 2008/0235277 A1
(43) Pub. Date: Sep. 25, 2008

(54) System and method for temporal recall of related items in an information workspace

(75) Inventors: Boban Mathew, Arlington, VA (US); Thomas John, Austin, TX (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sonolink Communications Systems, LLC

(21) Appl. No.: 11/726,778

(22) Filed: Mar. 22, 2007

(51) Int. Cl. G06F 7/00

(52) U.S. Cl. 707/104.1; 707/E17.01

(57) ABSTRACT

A system and method are described for recording events in different applications within a workspace. For example, a system according to one embodiment of the invention comprises: an action recorder module for generating event records representing actions performed by a user in a plurality of different applications over a period of time; a storage unit for storing the event records; a past time selector module to select a past time period of recorded event records in response to user input; an event recaller module to retrieve event records related to each of the applications over the past time period from the storage unit; and a graphical user interface to graphically display actions associated with event records occurring in each of the applications over the past time period, the graphical user interface arranged to illustrate a temporal relationship between actions occurring in each of the different applications.

### BACKGROUND

1. Field of the Invention

This invention relates generally to the field of document management systems. More particularly, the invention relates to a system and method for temporal recall of related items in an information workspace.

2. Description of the Related Art

Computer users typically work with different types of information within the same time period. For instance, a user may read email, make some phone calls, check on some reports, modify some documents, check on upcoming tasks and meetings or enter information about business contacts—all within the span of a few minutes. In short, users deal with a variety of different types of items within their information workspace. An information workspace may be more than a user's own computer and may include shared storage devices as well as items accessed through the Internet.

Users also spend a considerable amount of time looking for information related to their activities. For instance, when preparing a report or a proposal, users typically try to recall earlier actions involving related items. As the size of the user's information workspace grows, the memory of past actions becomes increasingly vague. Experiments have shown that indeed the memory of past events, even just those a day old, is fragile and could be augmented with snapshots of past activity. See, e.g., M Czerwinski, E Horvitz, An Investigation of Memory for Daily Computing Events Proceedings of HCI 2002, 2002, ftp.research.microsoft.com/pub/ejh/HCI2002paper.pdf

Many systems attempt to indicate related items. Hyperlinks are often used, especially in Internet documents, to indicate explicitly related items. Such links indicate a static view of related pieces of information and do not have much relevance to a user's actions at a certain time. Another way to indicate related items is to classify them into folder structures. This requires explicit user action that leads to poor organization, especially given the changing nature of information. Folder structures also typically do not collect information belonging to different types of items in a workspace.

Many computer systems record the history of past actions. For example, web browsers typically show users the sites accessed during the past day, past week etc. While this may include related items, the temporal relationship between items is not shown in these systems. Further, the history is retained for a single application (i.e., the Web browser) rather than for all applications in the system. Some operating systems retain more information, but here also they tend to join information into statistical tables and do not keep information about related items in terms of access within a related time interval.

An appropriate level of granularity is needed to recording useful information without recording excessive amounts of information. This limits the usefulness of systems that are not part of an information workspace. For example Rekimoto, J. Time-machine computing: A Time-centric approach for the information environment. Proceedings of the ACM UIST'99, www.csl.sony.co.jp/person/rekimoto/papers/uist99.pdf, involves recording temporal events that are associated, but without support from the information workspace to record information at an appropriate level of detail.

Accordingly, what is needed is a way to associate items in an information workspace in time-based records which may then be used to provide users temporal information about related pieces of information from their workspace.

### SUMMARY

A system and method are described for recording events in different applications within a workspace. For example, a system according to one embodiment of the invention comprises: an action recorder module for generating event records representing actions performed by a user in a plurality of different applications over a period of time; a storage unit for storing the event records; a past time selector module to select a past time period of recorded event records in response to user input; an event recaller module to retrieve event records related to each of the applications over the past time period from the storage unit; and a graphical user interface to graphically display actions associated with event records occurring in each of the applications over the past time period, the graphical user interface arranged to illustrate a temporal relationship between actions occurring in each of the different applications.

### BRIEF DESCRIPTION OF THE DRAWINGS

A better understanding of the present invention can be obtained from the following detailed description in conjunction with the following drawings, in which:

FIG. 1 illustrates a user workspace according to one embodiment of the invention.

FIG. 2 illustrates an action recorder for generating event records according to one embodiment of the invention.

FIG. 3 illustrates an event recaller for recalling stored event records according to one embodiment of the invention.

FIGS. 4a-d illustrate graphical user interfaces for graphically displaying recalled events according to one embodiment of the invention.

### DETAILED DESCRIPTION OF PREFERRED EMBODIMENTS

Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Note that in this detailed description, references to “one embodiment” or “an embodiment” mean that the feature being referred to is included in at least one embodiment of the invention. Moreover, separate references to “one embodiment” in this description do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Described below is a system and method for temporal recall of related items in an information workspace. More specifically, one embodiment of the system and method uses associations between temporal events in a database to help users recollect past activity. This association is done within an information workspace that includes items commonly needed in a computer work environment, as well as specialized items associated with specific external applications that are not directly controlled by the workspace (i.e., products of external applications such as documents which are available within the information workspace).

In one embodiment of the invention, the database records creation, deletion and modification events involving items in the workspace. The database records enough information to identify the items and their changes. However, in one embodiment, the database does not record every editing action within external applications. For example, the database may record information related to a text document being modified at a certain time, but does not record information about the characters added or deleted from the document. For applications within the control of the workspace, greater details may be recorded. For example, if the workspace maintains contact information about users, each creation, deletion or modification of a contact information item is identified as an event in the database. The relationship between the event database and the workspace produce information at a sufficient level of granularity without storing a very large set of actions.

Information stored in the database is used later to help users recollect past actions. As described in detail below, the information workspace is equipped with a recollection module for executing the temporal recall method. In addition, one embodiment of the invention includes a graphical user interface allowing users to move through various time periods, at various speeds, and visually notice related items as they appear and fade away.

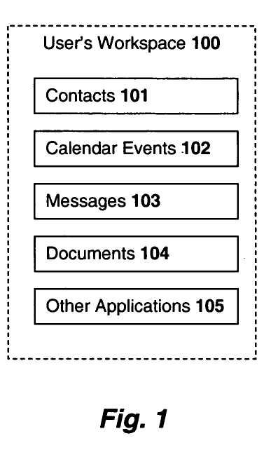

In one embodiment of the invention, related items for temporal recall occur within an information workspace 100, as shown in FIG. 1. The information workspace contains areas specifically designated for common office activities. The figure identifies several areas:

Contacts 101: This is information related to other people, both inside and outside the user's organization.

Calendar Events 102: This includes data normally placed within a user's calendar. They may be individual tasks and reminders but also generally include group activities such as meetings.

Messages 103: This portion of the workspace is an area holding messages of all types including, but not limited to, email messages, voicemails and text messages.

Documents 104: External applications that are not within the control of the information workspace create items that are designated as “documents.” For example, a specialized editing program may create a text document or a document formatted according to a particular word processor file format (e.g., Microsoft Word®).

Other Applications 105: These are applications that may be important to the common activities of the user and varies based on the user's work. For example for a news editor, a streaming area of incoming news may be an important part of the workspace, while for a delivery scheduler, a map application may be a central component.

In one embodiment of the invention, the workspace 100 includes all of the features described in U.S. Pat. No. 7,027,463, entitled SYSTEM AND METHOD FOR MULTI-TIERED RULE FILTERING, which is assigned to the assignee of the present application and which is incorporated herein by reference.

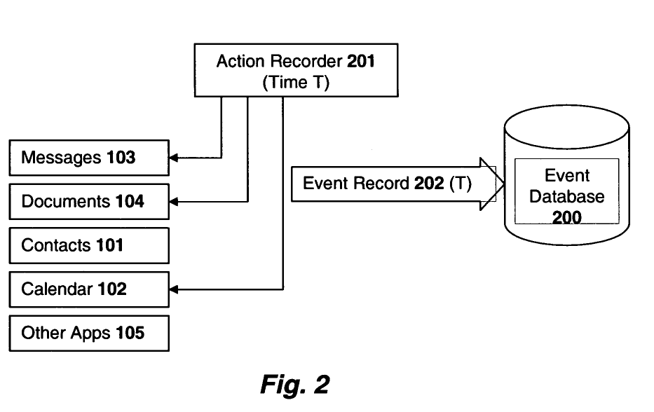

In one embodiment illustrated in FIG. 2, as the user works within an information space, an action recorder module 201 stores information about the user's activity. Specifically, the recorder module generates event records 202 representing actions within different applications and stores the event records 202 in an event database 200 at the level of granularity appropriate for the workspace. Thus changes to messages 103, documents 104, contacts 101, calendar events 102 and/or other applications 105 are recorded as individual items by the action recorder module 201. The event database 200 may be implemented using any common relational database or even a simpler associative hash table.

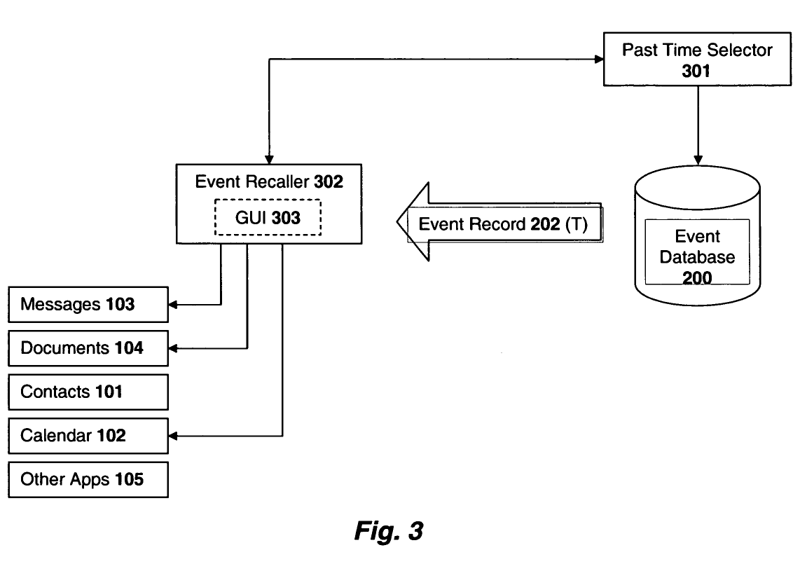

When the user tries to recall events from the past, this process is reversed as shown in FIG. 3. The user indicates a past time period through a past time selector module 301. The time period may be specified in a variety of ways (e.g., by specifying a day, a start date/time and end date/time, etc). In response, an event recaller module 302 fetches a set of event records 202 from the event database 200 associated with the specified time period. The event recaller module 302 then renders this information within a graphical user interface 303 on the user's workspace. Although illustrated as part of the event recaller module 302 in FIG. 3, in one embodiment of the invention, the graphical user interface 303 is a separate application.

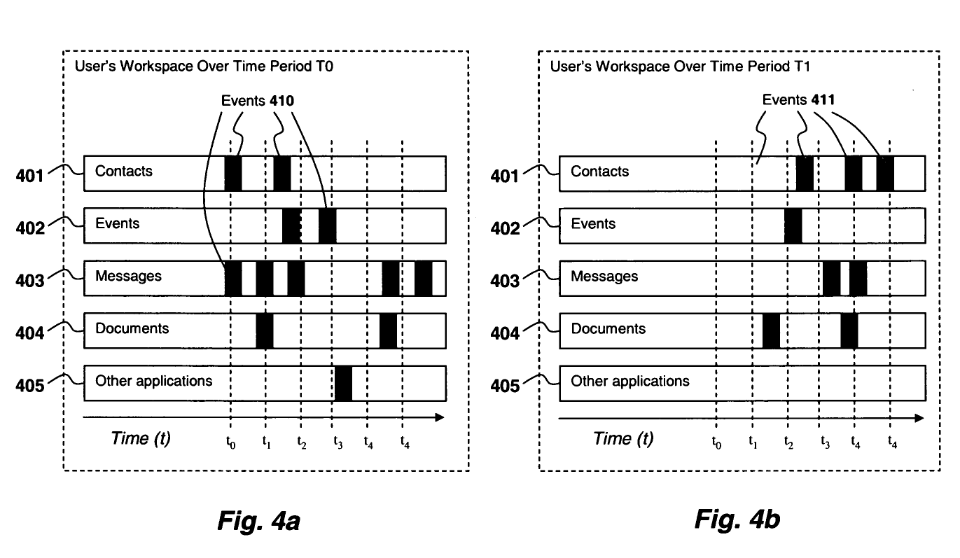

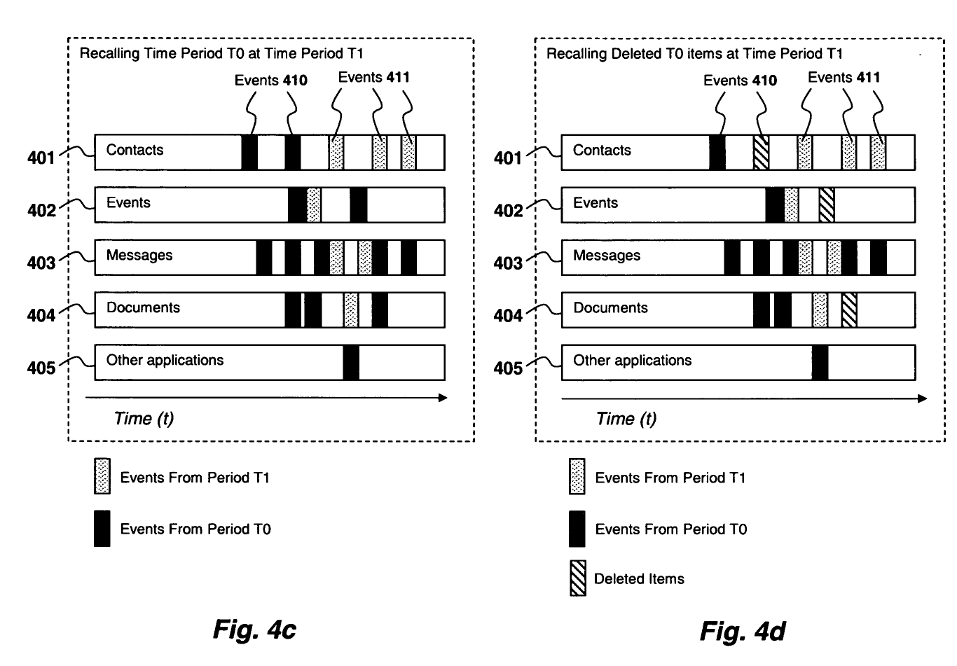

FIG. 4a illustrates one embodiment of the GUI 303 for rendering recorded events in the user's workspace. Related items accessed during a certain time period T0 can be considered as a “snapshot” of the user's workspace as shown at the top left of the figure. In the specific example shown in FIG. 4a, separate event timelines are generated for each of the user's workspace applications such as contacts 401, calendar events 402, messages 403, documents 404, and other applications 405. Highlighted event regions 410 within each event timeline indicate events which occurred during the time period at specified periods of time. The events 410 are temporally arranged along each respective timeline so that, upon viewing, the user can recall the what he/she was doing during the specified time period, and visually identify related events. For example, in FIG. 4a, at or around time to, the user generated a contacts event (e.g., by entering a new contact, deleting a contact, modifying a contact, etc) and a messages event (e.g., sending an email/instant message, reading an email/instant message, deleting an email/instant message). Given the temporal relationship between these events, there is a good chance that the events are related. Thus, the snapshot in time shown in FIG. 4a is capable of revealing related items even though the items belong to different applications.

In one embodiment, each of the event regions 410 provides an indication as to the specific event which occurred. For example, if the user deleted a contact, text and/or graphics indicating that a contact was deleted is provided within the event region (and/or adjacent to the event region). Alternatively, or in addition, the user can select an event region 410 or series of event regions using a mouse, keyboard, or other cursor control device to retrieve detailed information related to the event or series of events.

During a later time period, T1, the snapshot will be different as shown in FIG. 4b. For example, a different series of events 411 are shown in FIG. 4b for each timeline.

When the time period T0 is recalled after time period T1, the display may change to recall the view that existed at time T0 and overlap the views of T1 and T0 as shown in FIG. 4c. The recalled information may be rendered in different ways. In one embodiment, the recalled items 410 (from period T0) may be emphasized in the display while the current items 411 (from period T1) may be shown in a faded format. In addition, as shown in FIG. 4d, items that may no longer exist in the workspace (e.g., items that have been deleted) may be shown in a different format to show their current status. For example, in Figure 4d, one of the two events related to contacts from time period T0 has been highlighted using a different graphic to indicate that a contact has been deleted.

One of the benefits of the foregoing manner of overlapping time periods is that it allows the user to compare periods to note the change between the periods. This may illustrate, for example, the amount of work done, a shift in area of concentration, and/or areas suffering from neglect.

For a more specific example, suppose T1 is the current period. Suppose the graphical timeline illustrated seven folders in the current period (T1) but in a previous period (T0) there were only two of these folders on the workspace. Then the overlaid view will show that five more folders were added after time T0.

The term “computer-readable medium” as used herein refers to any medium that participates in providing instructions to a processor for execution. Such a medium may take many forms including, but not limited to, non-volatile media, volatile media, and transmission media. Non-volatile media include, for example, optical or magnetic disks, such as any of the storage devices in the system of FIGS. 2-3. Volatile media include dynamic memory, such as random access main memory. Transmission media include coaxial cables, copper wire, fiber optics, and also the wires that comprise a bus within a computer system. Transmission media can also take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other medium from which a computer can read. Various forms of computer-readable media may be involved in carrying one or more sequences of one or more instructions to a processor for execution. Additionally, program code for implementing the described operations may be in the form of computer instructions in any form (e.g., source code, object code, interpreted code, etc) stored in or carried by any computer- or machine-readable medium.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A system for linking workspace events over a period of time comprising:
an action recorder module for generating event records representing actions performed by a user in a plurality of different applications over a period of time;
a storage unit for storing the event records;
a past time selector module to select a past time period of recorded event records in response to user input;
an event recaller module to retrieve event records related to each of the applications over the past time period specified by the past time selector module from the storage unit; and
a graphical user interface to graphically display actions associated with event records occurring in each of the applications over the past time period, the graphical user interface arranged to illustrate a temporal relationship between actions occurring in each of the different applications.

2. The system as in claim 1 wherein the different applications include two or more of the group consisting of:
messaging applications;
calendar applications;
contacts applications; and
document applications.

3. The system as in claim 1 wherein the graphical user interface includes logic for overlaying actions associated with event records occurring in each of the applications over the past time period with actions associated with event records occurring in each of the applications over a later time period.

4. The system as in claim 1 wherein the graphical user interface further comprises:
a plurality of separate event timelines, one for each of the different applications, each of the event timelines corresponding to the selected time period; and
a plurality of action highlight elements displayed on each of the event timelines, the action highlight elements identifying actions occurring during the period of time with each of the applications.

5. The system as in claim 1 wherein the storage unit is a database.

6. The system as in claim 1 wherein actions relating to deleted items from the first time period are illustrated using different graphical indications than actions which are not related to deleted items.

7. A computer-implemented method for linking workspace events over a period of time comprising:
generating event records representing actions performed by a user in a plurality of different applications over a period of time;
storing the event records in a storage unit;
selecting a past time period of recorded event records in response to user input;
retrieving event records related to each of the applications over the past time period specified by the past time selector module from the storage unit; and
graphically displaying actions associated with event records occurring in each of the applications over the past time period in a graphical user interface, the graphical user interface arranged to illustrate a temporal relationship between actions occurring in each of the different applications.

8. The method as in claim 7 wherein the different applications include two or more of the group consisting of:
messaging applications;
calendar applications;
contacts applications; and
document applications.

9. The method as in claim 7 further comprising:
overlaying actions associated with event records occurring in each of the applications over the past time period with actions associated with event records occurring in each of the applications over a later time period within the graphical user interface.

10. The method as in claim 7 further comprising:
displaying a plurality of separate event timelines within the graphical user interface, one for each of the different applications, each of the event timelines corresponding to the selected time period; and
displaying a plurality of action highlight elements on each of the event timelines, the action highlight elements identifying actions occurring during the period of time with each of the applications.

11. The method as in claim 7 wherein the storage unit is a database.

12. The method as in claim 7 wherein actions relating to deleted items from the first time period are illustrated using different graphical indications than actions which are not related to deleted items.

13. A machine-readable medium having program code stored thereon which, when executed by a machine, causes the machine to perform the operations of:
generating event records representing actions performed by a user in a plurality of different applications over a period of time;
storing the event records in a storage unit;
selecting a past time period of recorded event records in response to user input;
retrieving event records related to each of the applications over the past time period specified by the past time selector module from the storage unit; and
graphically displaying actions associated with event records occurring in each of the applications over the past time period in a graphical user interface, the graphical user interface arranged to illustrate a temporal relationship between actions occurring in each of the different applications.

14. The machine-readable medium as in claim 13 wherein the different applications include two or more of the group consisting of:
messaging applications;
calendar applications;
contacts applications; and
document applications.

15. The machine-readable medium as in claim 13 comprising additional program code to cause the machine to perform the operations of:
overlaying actions associated with event records occurring in each of the applications over the past time period with actions associated with event records occurring in each of the applications over a later time period within the graphical user interface.

16. The machine-readable medium as in claim 13 comprising additional program code to cause the machine to perform the operations of:
displaying a plurality of separate event timelines within the graphical user interface, one for each of the different applications, each of the event timelines corresponding to the selected time period; and
displaying a plurality of action highlight elements on each of the event timelines, the action highlight elements identifying actions occurring during the period of time with each of the applications.

17. The machine-readable medium as in claim 13 wherein the storage unit is a database.

18. The machine-readable medium as in claim 13 wherein actions relating to deleted items from the first time period are illustrated using different graphical indications than actions which are not related to deleted items.
